(19) United States
(12) Patent Application Publication
(10) Pub. No.: US 2013/0305870 A1
(43) Pub. Date: Nov. 21, 2013

(54) SYSTEM AND METHOD FOR CONSTRAINING A PORTION OF A STEERING COLUMN ASSEMBLY TO TRANSLATE ALONG A PREFERRED PATH

(71) Applicants: Joseph R. Streng, Freeland, MI (US); Chad E. Gerding, Chesaning, MI (US); Neal R. Roller, Essexville, MI (US)

(72) Inventors: Joseph R. Streng, Freeland, MI (US); Chad E. Gerding, Chesaning, MI (US); Neal R. Roller, Essexville, MI (US)

(73) Assignee: STEERING SOLUTIONS IP HOLDING CORPORATION, Saginaw, MI (US)

(21) Appl. No.: 13/476,311

(22) Filed: May 21, 2012

(51) Int. Cl. B62D 1/185; B23P 11/00

(52) U.S. Cl. 74/493; 29/428

(57) ABSTRACT

A method for constraining an upper portion of a steering column assembly of a vehicle to translate along a preferred path comprises providing a telescoping steering column assembly with an upper column positioned for use by a vehicle operator and with a power assist module positioned remotely from the vehicle operator. A position lock bracket is disposed about the upper column, and the position lock bracket is conditionally fixed to the vehicle. A guide bracket is fixed to the vehicle and configured so as to constrain the upper column to translate along the preferred path. A steering column assembly comprises an upper column and a power assist module. A position lock bracket is disposed about the upper column and conditionally fixed to the vehicle. A guide bracket is fixed to the vehicle and configured so as to constrain the upper column to translate along a preferred path.

### BACKGROUND OF THE INVENTION

In the event of a vehicle crash, the steering column can play an important roll in absorbing and dissipating the kinetic energy of vehicle occupants relative to the vehicle, often mitigating injuries to the occupants. A steering column may dissipate the kinetic energy in a number of ways including allowing for a controlled collapse of the steering column under a resistive load.

In many vehicles, the steering column is positioned such that a longitudinal axis of the column is positioned at an angle relative to a horizontal plane along a longitudinal axis of the vehicle (i.e., from the rear of the vehicle toward the front of the vehicle). A steering column is typically configured to collapse along this longitudinal axis. Therefore, energy dissipation occurs as a vehicle occupant exerts a force against the collapsing steering column while moving along the direction in which the steering column collapses.

It is recognized, however, that a significant proportion of kinetic energy that must be dissipated in vehicle collisions is in a horizontal direction. For front end collisions, the kinetic energy must be dissipated along the longitudinal axis of the vehicle. Consequently, it is desirable to have a steering column assembly configured to collapse along a horizontal direction along the longitudinal axis of the vehicle, rather than in a direction that deviates from the horizontal, longitudinally oriented direction. Unfortunately, the incorporation of a power assist module into a steering column assembly typically introduces a number of packaging issues that complicate efforts to configure the steering column assembly so as to accommodate a controlled collapse along a horizontal, longitudinally oriented direction. One significant reason for this impracticability is related to the typical need to allow the power assist module to translate horizontally with the collapsing column.

Accordingly, it is desirable to have a steering column assembly wherein the steering column is constrained to move horizontally along the longitudinal direction, without requiring the power assist module to also translate in the same horizontal, longitudinally oriented direction.

### SUMMARY OF THE INVENTION

In one exemplary embodiment of the invention, a method for constraining an upper portion of a steering column assembly of a vehicle to translate along a preferred path comprises providing a telescoping steering column assembly with an upper column positioned for use by a vehicle operator and with a power assist module positioned remotely from the vehicle operator. A position lock bracket is disposed about the upper column, and the position lock bracket is conditionally fixed to the vehicle. A guide bracket is fixed to the vehicle and configured so as to constrain the upper column to translate along the preferred path.

In another exemplary embodiment of the invention, a steering column assembly comprises an upper column positioned for use by a vehicle operator and a power assist module positioned remotely from the vehicle operator. A position lock bracket is disposed about the upper column and conditionally fixed to the vehicle. A guide bracket is fixed to the vehicle and configured so as to constrain the upper column to translate along a preferred path.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a perspective view of an exemplary steering column assembly with an integrated power assist module;

FIG. 2 shows a view of an exemplary steering column assembly with an integrated power assist module;

FIG. 3 shows a partial view of an exemplary steering column assembly;

FIG. 4 shows a view of an exemplary steering column assembly in an operational condition;

FIG. 5 shows a view of an exemplary steering column assembly in a collapsed condition; and

FIG. 6 is a process flow chart showing an exemplary method for constraining an upper portion of a steering column assembly of a vehicle to translate along a preferred path.

### DETAILED DESCRIPTION

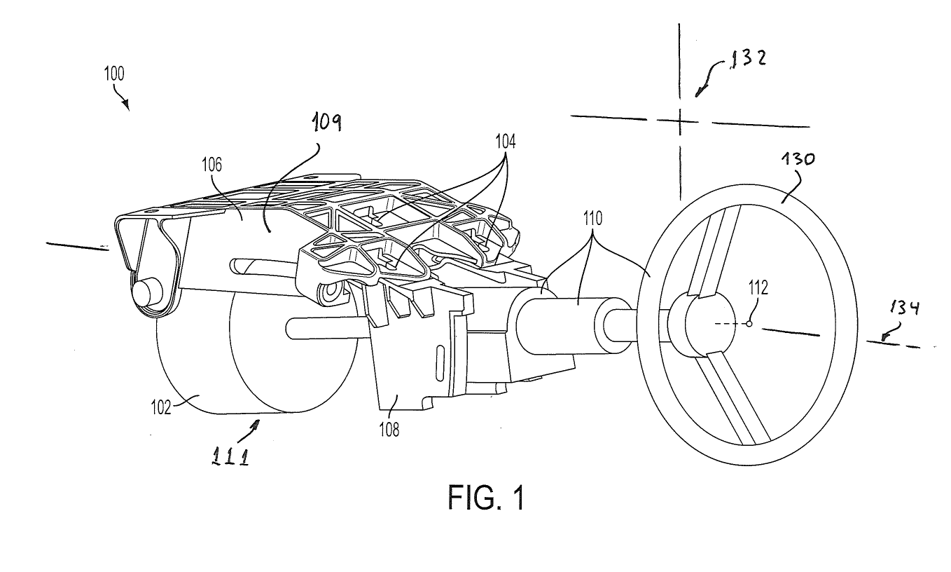

Referring now to the Figures, where the invention will be described with reference to specific embodiments, without limiting same, FIG. 1 shows a perspective view of a steering column assembly 100 with an integrated power assist module 102. As shown in FIG. 1, the steering column assembly 100 comprises an upper column 110 that supports a steering wheel 130 positioned proximate an operator (not shown) of the vehicle. In the exemplary embodiment of FIG. 1, the integrated power assist module 102 is positioned at a lower end 111 of the steering column assembly 100, remotely from both the steering wheel 130 and the vehicle operator. The steering column assembly 100 is arranged in a plane 132 that is oriented vertically and that includes a longitudinal axis 134 of the vehicle.

The steering column assembly 100 includes a position lock bracket 108 disposed about the generally cylindrical upper column 110. Position lock bracket 108 facilitates selectively enabling and preventing adjustments to the position of the steering wheel 130. To accomplish this, the position lock bracket 108 is configured to be fixed with respect to the upper column 110 when the position lock bracket 108 occupies a locked mode while also being configured to be moveable relative to the upper column 110 when the position lock bracket 108 occupies an adjustment mode. In embodiments that provide for telescoping adjustments of the steering column assembly 100, the position lock bracket 108 is configured to selectively provide for such telescoping adjustments while in an adjustment mode and to prevent such telescoping adjustments while in the locked mode. Similarly, in embodiments that provide for raking adjustments of the steering column assembly 100, the position lock bracket 108 is configured to selectively provide for such raking adjustments while in an adjustment mode and to prevent such raking adjustments while in the locked mode.

During normal operation of the vehicle, the position lock bracket 108 is fixed to the vehicle, and the position lock bracket 108 occupies a locked mode such that the position lock bracket 108 is also fixed to the upper column 110. To enhance vehicle safety in situations in which the vehicle encounters an excessive acceleration such that a vehicle occupant may impact or press against the steering column, the position lock bracket 108 may be configured to selectively release from the vehicle. For example, the position lock bracket 108 (and/or the mechanism that fixes the position of the position lock bracket 108 relatively to the vehicle) may be configured such that, upon the occurrence of a predefined event (such as a collision involving the vehicle, a vehicle acceleration that exceeds a predetermined threshold magnitude, or another trigger event sensed or deduced by a vehicle controller), the position lock bracket 108 (and the upper column 110 with respect to which the position lock bracket 108 may be positionally locked) releases, or is released, from its fixed attachment to the vehicle. As such, the position lock bracket 108 is configured so that, upon such release, it may be able to move relatively to the vehicle in at least one direction, such as along a horizontal direction along the longitudinal axis 134 of the vehicle.

In an exemplary embodiment, a guide bracket 106 is attached to the vehicle and disposed adjacent to the position lock bracket 108 so as to define a bracket wall 109 that is arranged parallel to the horizontal axis 134. In one exemplary embodiment, the guide bracket 106 includes a plurality of attachments 104 that cooperate with the position lock bracket 108 to selectively fix the position lock bracket 108 to the guide bracket 106, and therefore to the vehicle. Alternatively, the attachments 104 may be provided between the position lock bracket and another structure of the vehicle other than the guide bracket 106. In an exemplary embodiment, attachments 104 are configured such that, when an acceleration of the vehicle exceeds a predetermined threshold magnitude, the attachments 104 break so as to release the position lock bracket 108 from its fixed attachment to the vehicle. In any event, the attachments 104 provide a means for fixing the position lock bracket 108 and the upper column 110 in nominal mounting position, while also facilitating release of the steering column assembly in the event of a sudden deceleration involving the vehicle.

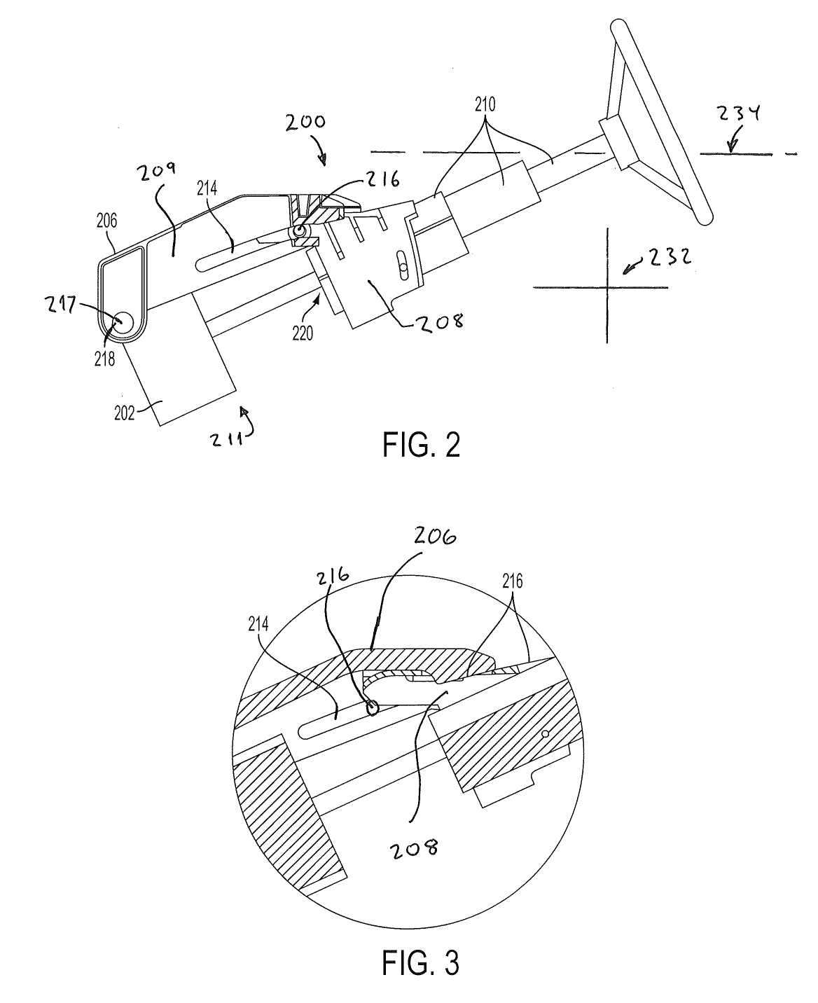

In an exemplary embodiment, as shown in FIG. 2, a guide bracket 206 is positioned so as to extend from the upper column 210 to the power assist module 202 positioned at a lower end 211 of the steering column assembly 200. The guide bracket 206 is also configured to cooperate with a position lock bracket 208 so as to constrain collapsing movement of the upper column 210 along a horizontal direction along the longitudinal axis 234 of the vehicle. In this embodiment, the guide bracket 206 defines one or more guide channels 214 in the bracket wall 209, along (e.g., within) which a guide post 216 of the position lock bracket 208 is constrained to move. Accordingly, the position lock bracket 208 and the upper column 210 are configured so that their relative movement must occur along the defined path of the guide channel 214 which is arranged so that the upper column 210 moves in a desired direction during a collapse of the steering column assembly 200.

In an exemplary embodiment, the desired direction during a collapse of the steering column assembly 200 is along (i.e., parallel to) the longitudinal axis 234 of the vehicle. As a result, since a vehicle occupant is likely to move in a horizontal direction along the longitudinal axis 234 of the vehicle during a rapid deceleration of the vehicle, and since the upper column 210 is constrained to also move in a horizontal direction along the longitudinal axis 234 of the vehicle, relative movement between a vehicle occupant and the steering wheel 212 may be reduced during a sudden deceleration of the vehicle.

As shown in FIG. 2, the guide bracket 206 may also provide for attachment to the power assist module 202. In accordance with such embodiments, such attachment facilitates rotation of the power assist module 202 in a vertical plane 232 while also restraining translational movement of the power assist module 202 relatively to the vehicle. To provide such attachment of the power assist module 202 while also facilitating rotation of the power assist module 202 relatively to the vehicle, an exemplary guide bracket 206 defines a receptacle 217 through which a pin 218 extends horizontally, transversely to the longitudinal axis 234 of the vehicle. Pin 218 protrudes from the power assist module 202 and provides support to the power assist module 202 relative to the receptacle 217 and the guide bracket 206 that defines the receptacle 217.

Accordingly, even as the upper column 210 may be capable of translational movement, constrained to be substantially parallel to a horizontal direction, the power assist module 202 may be prevented from translating relative to the vehicle. In an exemplary embodiment, the power assist module 202 is pivotably coupled to the guide bracket 206 by means of the pivot joint that is formed by the combination of the receptacle 217 defined in the guide bracket 206 and the pin 218 that protrudes from the power assist module 202, substantially transversely to the longitudinal axis 234 of the vehicle. Such an arrangement allows the power assist module 202 to rotate about the pin 218 in a deceleration event while eliminating the need for the power assist module 202 to translate. Since the pivot joint does not translate, a more robust connection to the guide bracket 206 may be facilitated. It should be appreciated that a telescoping coupler 220 is used to join the power assist module 202 to the upper column 210. This telescoping coupler 220 allows the upper column 210 to translate forward (i.e., to decrease in length) in the vehicle while maintaining torsional connection to the power assist module 202, which does not translate, but only rotates.

FIG. 3 is an expanded view showing a portion of a guide bracket 206 which defines a guide channel 214 along (e.g., within) which a guide post 216 of the position lock bracket 208 is constrained to move. Thus, even though the attachments may have released the position lock bracket 208 from a state of being fixed to the vehicle, one or more guide channels 214 may be arranged and configured to cooperate with one or more corresponding guide posts 216 so as to constrain the upper column 210 to move in a substantially horizontal direction along the longitudinal axis of the vehicle.

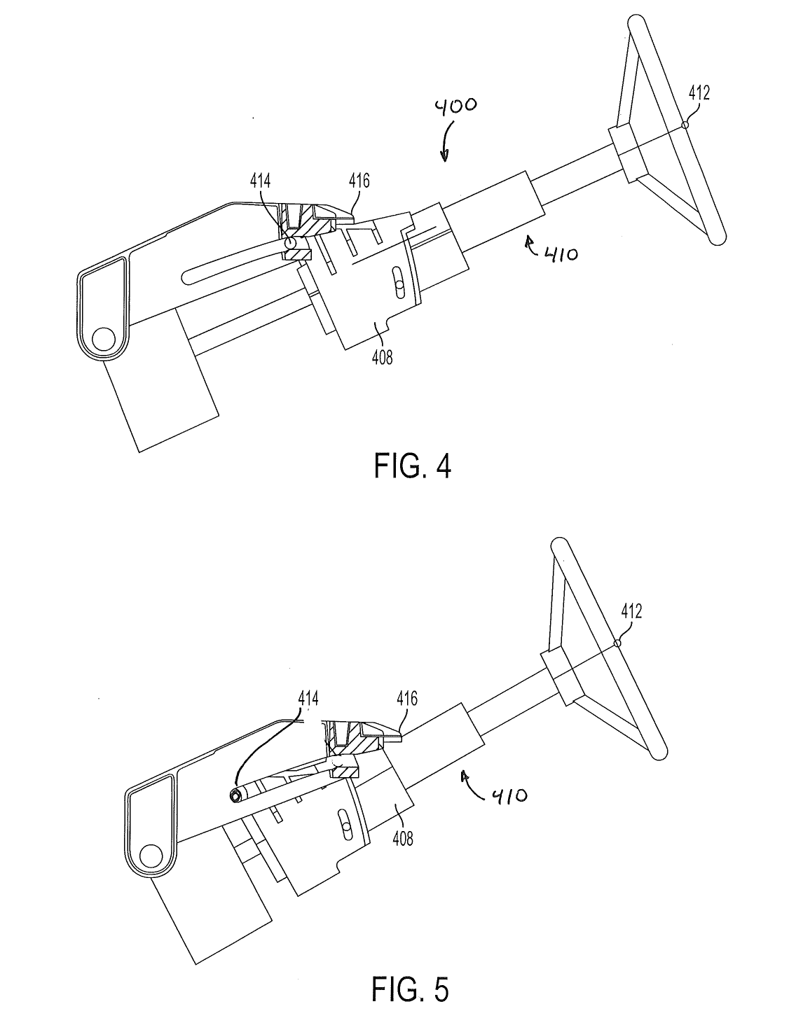

FIG. 4 shows an exemplary steering column assembly 400 in a normal operating configuration wherein attachments (not shown) provide for a fixed positioning of the upper column 410 relative to the vehicle. As shown in FIG. 5, the attachments (not shown) have released such that the upper column 410 has been able to translate along the horizontal direction as the pin 418 that is fixed to the position lock bracket 408 has moved along the guide channel 414 through a full compression/deceleration stroke.

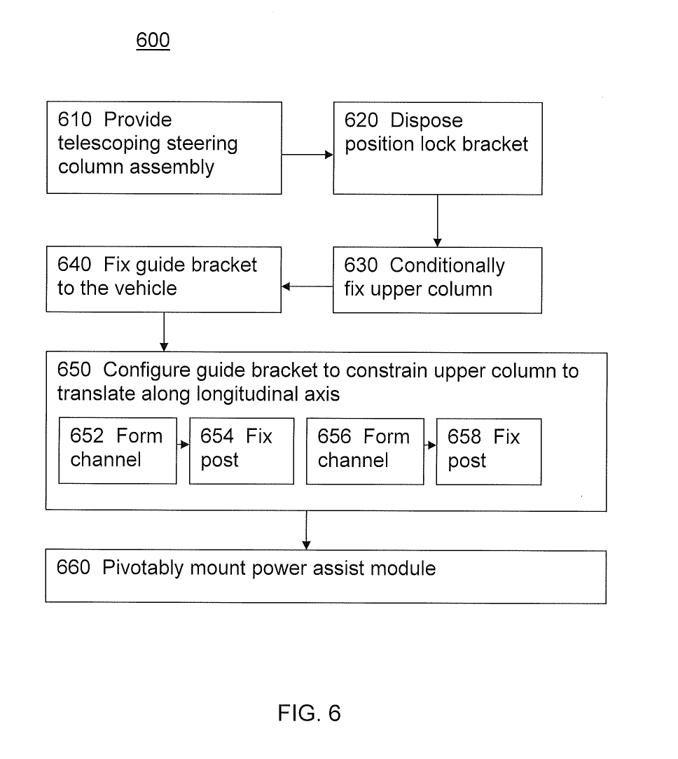

FIG. 6 is a flow chart showing an exemplary method for constraining an upper portion of a steering column assembly to move horizontally along a longitudinal axis of a vehicle, without requiring the power assist module to also translate in the same horizontal, longitudinally oriented direction. In an exemplary method 600, a telescoping steering column assembly is provided (step 610) with an upper column positioned for use by a vehicle operator and with a power assist module positioned remotely from the vehicle operator. A position lock bracket is disposed (step 620) about the upper column and fixed (step 630) to the upper column and to the vehicle such that the upper column is positionally fixed relative to the vehicle during normal vehicle operation and such that the upper column is free to translate upon the occurrence of predetermined event such as a rapid deceleration of the vehicle (i.e., so that the upper column is conditionally fixed to the vehicle).

A guide bracket is fixed to the vehicle (step 640) and configured (step 650) so as to cooperate with the position lock bracket to constrain the upper column to translate in a horizontal direction along the longitudinal axis of the vehicle. In an exemplary embodiment, a guide channel is formed (step 652) in the guide bracket, and a guide post is fixed (step 654) to the position lock bracket so as to extend through the guide channel and to move along the guide channel as the upper column translates in a horizontal direction along the longitudinal axis of the vehicle. In an alternative embodiment, a guide channel is formed (step 656) in the position lock bracket, and a guide post is fixed (step 658) to the guide bracket so as to extend through the guide channel and to constrain translation of the upper column in a horizontal direction along the longitudinal axis of the vehicle.

The power assist module is mounted pivotably (step 660) to the vehicle so as to prevent translation of the power assist module relatively to the vehicle while facilitating rotation about a pivot oriented horizontally and transversely to the longitudinal axis of the vehicle as the upper column is allowed to translate along the longitudinal axis of the vehicle.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A method for constraining an upper portion of a steering column assembly of a vehicle to translate along a preferred path, the method comprising:
providing a telescoping steering column assembly with an upper column positioned for use by a vehicle operator and with a power assist module positioned remotely from the vehicle operator;
disposing a position lock bracket about the upper column;
conditionally fixing the position lock bracket to the vehicle; and
fixing a guide bracket to the vehicle and configuring the guide bracket so as to constrain the upper column to translate along the preferred path.

2. The method of claim 1, wherein the preferred path is along a longitudinal axis of the vehicle.

3. The method of claim 1, further comprising forming a guide channel in the guide bracket and fixing a guide post to the position lock bracket so as to extend through the guide channel and to move along the guide channel as the upper column translates in a horizontal direction along the longitudinal axis of the vehicle.

4. The method of claim 1, further comprising forming a guide channel in the position lock bracket and fixing a guide post to the guide bracket so as to extend through the guide channel and to constrain translation of the upper column in a horizontal direction along the longitudinal axis of the vehicle.

5. The method of claim 1, further comprising conditionally fixing the upper column to the vehicle such that the upper column is positionally fixed relative to the vehicle during normal vehicle operation and such that the upper column is free to translate upon the occurrence of predetermined event.

6. The method of claim 5, wherein the predetermined event comprises a rapid deceleration of the vehicle.

7. The method of claim 1, comprising pivotably mounting the power assist module to the vehicle so as to prevent translation of the power assist module relatively to the vehicle while facilitating rotation about a pivot oriented horizontally and transversely to the longitudinal axis of the vehicle as the upper column is allowed to translate along the longitudinal axis of the vehicle.

8. A steering column assembly comprising:
an upper column positioned for use by a vehicle operator;
a power assist module positioned remotely from the vehicle operator;
a position lock bracket disposed about the upper column and conditionally fixed to the vehicle; and
a guide bracket fixed to the vehicle and configured so as to constrain the upper column to translate along a preferred path.

9. The steering column assembly of claim 8, wherein the preferred path is along a longitudinal axis of the vehicle.

10. The steering column assembly of claim 8, wherein the guide bracket defines a guide channel and wherein a guide post is fixed to the position lock bracket so as to extend through the guide channel and to move along the guide channel as the upper column translates in a horizontal direction along the longitudinal axis of the vehicle.

11. The steering column assembly of claim 8, wherein the position lock bracket defines a guide channel and wherein a guide post is fixed to the guide bracket so as to extend through the guide channel and to constrain translation of the upper column in a horizontal direction along the longitudinal axis of the vehicle.

12. The steering column assembly of claim 8, wherein the upper column is conditionally fixed to the vehicle such that the upper column is positionally fixed relative to the vehicle during normal vehicle operation and such that the upper column is free to translate upon the occurrence of predetermined event.

13. The steering column assembly of claim 12, wherein the predetermined event comprises a rapid deceleration of the vehicle.

14. The steering column assembly of claim 8, wherein the power assist module is pivotably mounted to the vehicle so as to prevent translation of the power assist module relatively to the vehicle while facilitating rotation about a pivot oriented horizontally and transversely to the longitudinal axis of the vehicle as the upper column is allowed to translate along the longitudinal axis of the vehicle.

15. The steering column assembly of claim 14, wherein the guide bracket defines a receptacle, and wherein a pin is fixed to the power assist module so as to extend through the receptacle transversely to the longitudinal axis of the vehicle.

16. The steering column assembly of claim 8, further comprising a telescoping coupler for joining the power assist module to the upper column.

17. The steering column assembly of claim 16, wherein the telescoping coupler is configured to allows the upper column to translate while maintaining torsional connection to the power assist module.
